(19) United States
(12) Patent Application Publication
(10) Pub. No.: US 2014/0306430 A1
(43) Pub. Date: Oct. 16, 2014

(54) METHOD AND APPARATUS FOR ATTACHING A DRIVER AIRBAG MODULE TO A STEERING WHEEL

(71) Applicant: Ford Global Technologies, LLC, Dearborn, MI (US)

(72) Inventors: Timothy SCOTT, Benfleet (GB); James ALCORN, Chelmsford (GB); Martin FASSBENDER, Buschhoven (DE); Matthew SHYNN, Colchester (GB)

(73) Assignee: Ford Global Technologies, LLC, Dearborn, MI (US)

(21) Appl. No.: 14/249,047

(22) Filed: Apr. 9, 2014

(30) Foreign Application Priority Data
Apr. 10, 2013 (GB) 1306505.7

(51) Int. Cl. B60R 21/203

(52) U.S. Cl. CPC B60R 21/2035
USPC 280/728.2; 29/453

(57) ABSTRACT

A steering wheel and driver airbag assembly in which an airbag module having a container housing a driver airbag is attached to motor vehicle steering wheel by a single snap fastener having a first part on the steering wheel and a second part on the container. To attach the airbag module to the steering wheel a part of the container is brought into contact with the steering wheel, the container is then rotated about a transverse axis so as to engage the second part of the snap fastener located on the container with the first part of the snap fastener on the steering wheel. A pair of location means locate the container at a position spaced away from the single snap fastener.

### CROSS-REFERENCE TO RELATED APPLICATIONS

This application claims foreign priority benefits under 35 U.S.C. §119(a)-(d) to GB 1306505.7 filed Apr. 10, 2013, the disclosure of which is hereby incorporated by reference it its entirety.

### TECHNICAL FIELD

This invention relates to motor vehicle safety and in particular to a method and apparatus for attaching an airbag module to a steering wheel to form a steering wheel and driver airbag assembly for a motor vehicle.

### BACKGROUND

It is well known to provide a driver of a motor vehicle with an airbag stowed in a container fastened to a hub of a steering wheel. Such prior art arrangements often use complicated or expensive attachment means and are difficult to assemble.

### SUMMARY

It is an object of this invention to provide method and apparatus for attaching an airbag module to a steering wheel in which the driver airbag module is attached to the steering wheel in a simple and cost effective manner.

According to a first aspect of the invention there is provided a method for attaching an airbag module having one part of a single snap fastener thereon to a steering wheel having a second part of the single snap fastener thereon to form a steering wheel and driver airbag assembly the method comprising moving the airbag module at an angle to the steering wheel so as to cause contact to occur between part of the airbag module spaced away from the one part of the single snap fastener and the steering wheel and rotating the airbag module towards the steering wheel to cause the one part of the snap fastener to engage with the second part of the snap fastener thereby to attach the airbag module to the steering wheel.

The single snap fastener may comprise a single hook on one of the steering wheel and the airbag module for engagement with a single snap wire supported by the other of the steering wheel and the airbag module.

Two spaced apart location means may be provided on the airbag module for engagement with complementary location means on the steering wheel so as to locate the airbag module relative to the steering wheel wherein the rotation of the airbag module towards the steering wheel may cause the location means on the airbag module to be engaged with the location means on the steering wheel.

According to a second aspect of the invention there is provided a steering wheel and driver airbag assembly comprising an airbag container for attachment to a steering wheel having two location means spaced apart on opposite sides of a longitudinal center line of the airbag container for locating one end of the airbag container relative to the steering wheel and a single snap fastener having elements on the steering wheel and on the airbag container to retain an opposite end of the airbag container in position on the steering wheel, wherein the airbag container is attached to the steering wheel by rotation of the airbag container about a transverse axis spaced away from the single snap fastener so as to engage the two elements forming the single snap fastener thereby attaching the airbag container to the steering wheel.

The single snap fastener may comprise a single hook retainer on one of the steering wheel and the airbag container for engagement with a snap wire supported by the other of the steering wheel and the airbag container.

The two location means may comprise a pair of arms extending out from the airbag container for co-operation with apertures in part of the steering wheel.

The arms may extend out from a rear wall of the airbag container for co-operation with respective apertures formed in an armature of the steering wheel.

Alternatively, the arms may extend out from an end wall of the airbag container for co-operation with respective apertures in an airbag support forming part of the steering wheel.

Each arm may be a hook shaped arm.

Each of the two location means may comprises a pin extending out from a side wall of the airbag container for engagement with a respective L-shaped slot formed in part of the steering wheel.

Each of the L-shaped slots may have a first section having an upper open end with which a respective pin is engaged during attachment of the airbag container to the steering wheel wherein each of the pins may contact a side wall of the respective first arm at a respective contact point and the transverse axis of rotation may pass through both of the contact points.

Each of the pins may slide away from the open end of the respective first arm with which it is engaged as the airbag container is rotated to engage the single snap fastener thereby facilitating engagement of the pins with respective second sections of the L-shaped slots.

### BRIEF DESCRIPTION OF THE DRAWINGS

Embodiments of the present invention described herein are recited with particularity in the appended claims. However, other features will become more apparent, and the embodiments may be best understood by referring to the following detailed description in conjunction with the accompanying drawings, in which:

FIG. 1 is a front view of a steering wheel and driver airbag assembly according to the invention;

FIG. 2 is a pictorial view of a center portion of an armature of a steering wheel shown in FIG. 1 according to a first embodiment of the invention;

FIG. 3A is a cross-section through the armature along the line X-X on FIG. 2 showing a driver airbag container attached to the armature by a single snap fastener;

FIG. 3B is an enlarged view in the region 1′ on FIG. 3A showing the single snap fastener;

FIG. 4 is an end view of the driver airbag container shown in FIG. 3A;

FIG. 5 is a view similar to FIG. 3A but showing a second embodiment of the invention;

FIG. 6 is a pictorial view of a center portion of an armature of a steering wheel having a support for a driver airbag according to a third embodiment of the invention;

FIG. 7 is an end view of the support in the direction of the arrow ‘V’ on FIG. 6;

FIG. 8 is an underside view of a driver airbag for fitment to the support shown in FIGS. 6 and 7;

FIG. 9 is a side view in the direction of arrow ‘S’ on FIG. 8;

FIG. 10 is a side view similar to FIG. 9 but showing the driver airbag attached to the steering wheel armature via the support;

FIG. 11A is an end view of the support similar to that shown in FIG. 7 but showing one half of an alternative snap lock fastener;

FIG. 11B is a cross-section on the line Y-Y on FIG. 11A;

FIG. 12 is a cross-section similar to FIG. 11B but showing the driver airbag attached to the support via the alternative snap lock fastener; and

FIG. 13A to 13C show a fourth embodiment of the invention in three stages of assembly.

### DETAILED DESCRIPTION

As required, detailed embodiments of the present invention are disclosed herein;

however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

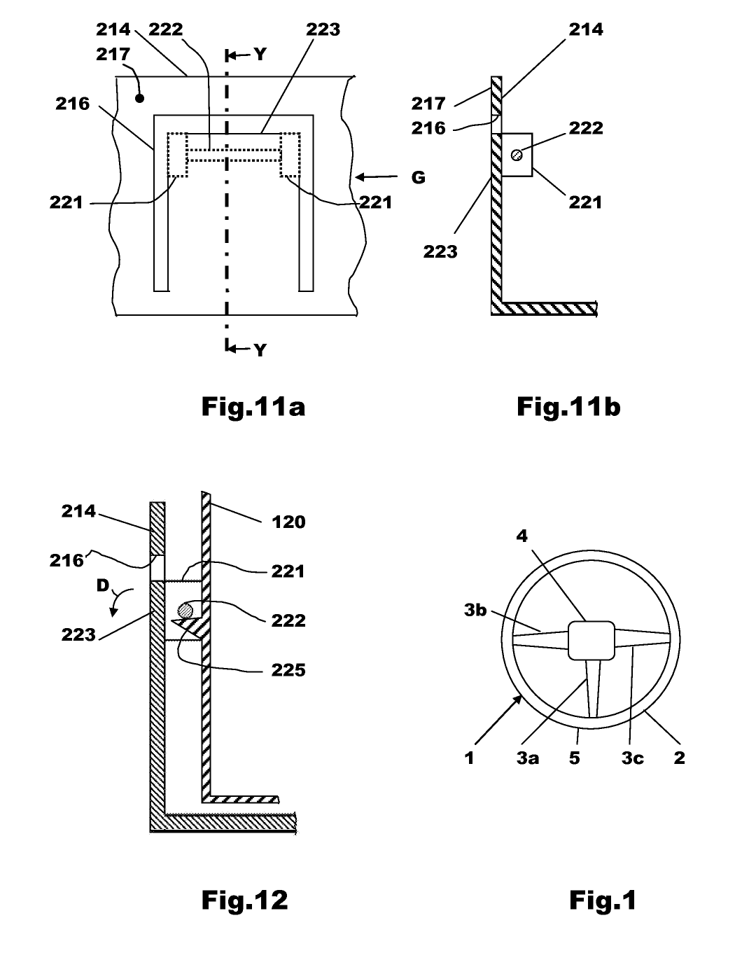

With reference to FIG. 1 there is shown a steering wheel and driver airbag assembly 1 comprising a steering wheel 5 having a rim 2 and three spokes 3A, 3B, 3C and a driver airbag module 4. When the vehicle is travelling in a straight line the steering wheel 5 is said to be in a straight ahead position and the spoke 3a is positioned, as shown in FIG. 1A, in a “6 o'clock position”.

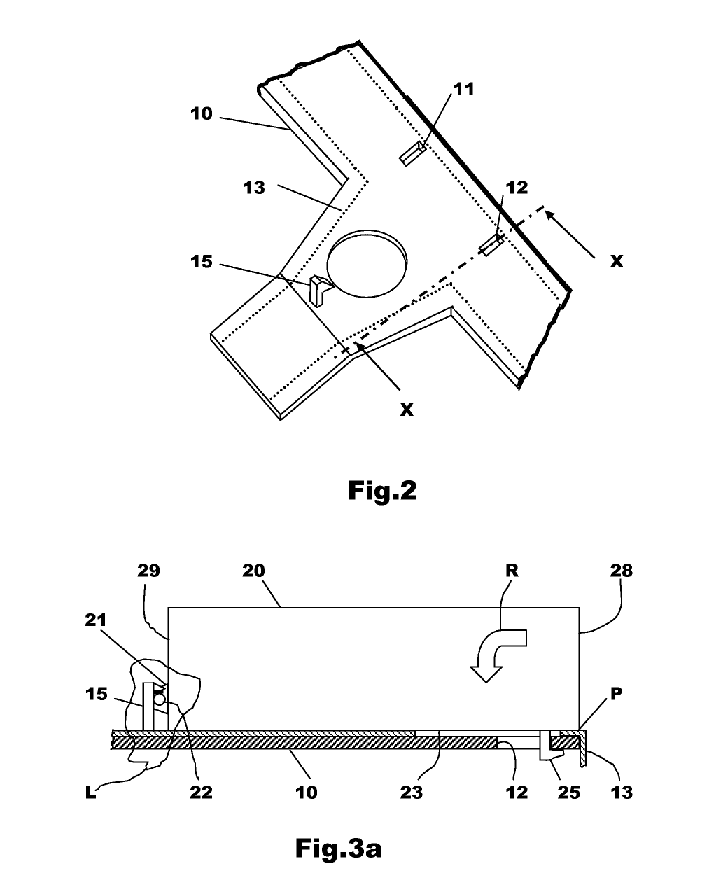

Referring now to FIGS. 2 to 4 there is shown in greater detail the steering wheel and driver airbag assembly 1.

The steering wheel 5 has an armature 10 made of magnesium or aluminum alloy covered partially by a trim member 13 such as a polyurethane cover. The edges of the trim member 13 are shown in dotted outline on FIG. 2. The armature 10 has a pair of spaced apart apertures 11, 12 formed in it which form one half of a location means for the driver airbag module 4. A hook retainer 15 extends out from the armature 10 and forms one half of a snap lock fastener.

The driver airbag module 4 is in the form of an airbag container 20 in which an airbag (not shown) is housed along with an inflator (not shown). The airbag is deployable out via a front side of the airbag container 20 and a cover or door (not shown) covering the front face of the airbag container 20 is provided through which the airbag is deployed.

The airbag container 20 has a pair of arms in the form of hook shaped members 25 extending out from a rear wall 23 thereof to form in combination with the apertures 11, 12 in the armature 10 a pair of spaced apart location means. The two hook shaped members 25 are positioned near to one end wall 28 of the airbag container 20 on either side of a center line ‘CL’ of the airbag container 20. A snap wire 22 is fastened to an opposite end wall 29 of the airbag container 20 via a pair of spaced apart lugs 21. The snap wire 22 forms in combination with the hook retainer 15 a single snap lock fastener and is used to attach the airbag container 20 to the steering wheel 5.

To assemble the airbag container 20 to the steering wheel 5, the airbag container 20 is first offered up to the armature 10 at an angle allowing any electrical connections to be made. The airbag container 20 is then moved further towards the armature 10 until a rear corner forming a pivot axis ‘P’ at the juncture of the one end wall 28 and the rear wall 23 contacts an upper surface of the armature 10 which in this case is covered by the trim member 13.

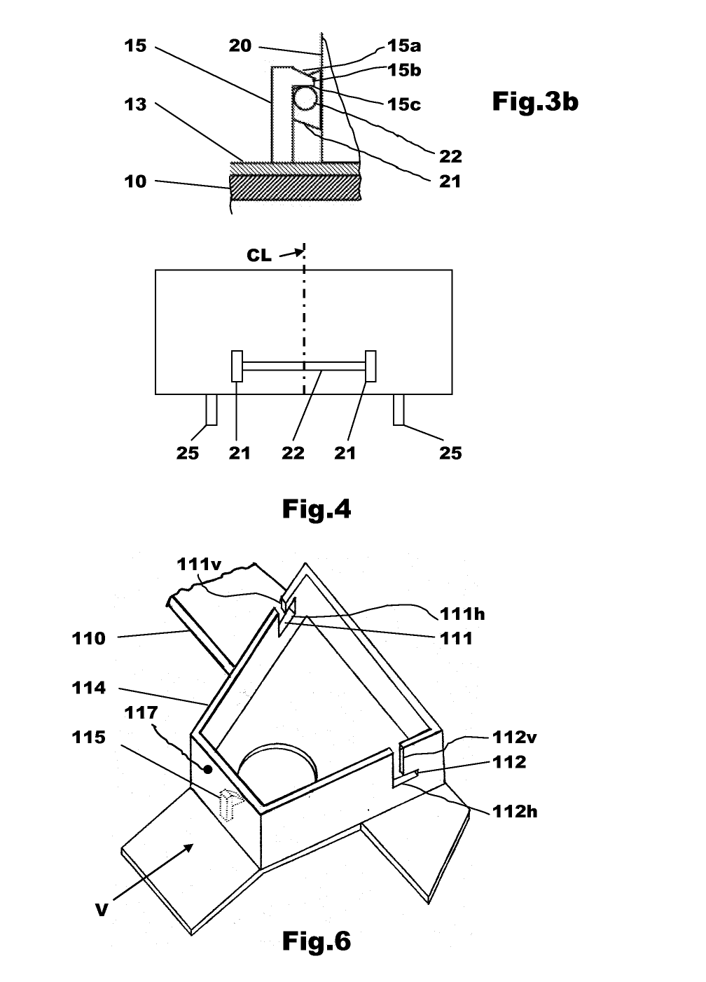

The airbag container 20 is then rotated in the direction of arrow ‘R’ on FIG. 3A causing the hook shaped members 25 to pass through the apertures 11, 12 until the snap wire 22 contacts an upper sloping surface 15a of the hook retainer 15.

Further rotation of the airbag container 20 in the direction of arrow ‘R’ causes the snap wire 22 to be deflected towards the end 29 of the adjacent airbag container 20 to which it is attached via the lugs 21. This allows the snap wire 22 to move down the upper sloping surface 15a until eventually it snaps past a tip 15b of the hook retainer 15 and becomes trapped under a flat lower surface 15c of the hook shaped retainer 15.

During the engagement of the snap wire 22 with the hook retainer 15, the airbag container 20 rotates about the pivot axis ‘P’ but at the same time moves axially away from the hook retainer 15 thereby fully engaging the ends of the two hook shaped members 25 with a rear face of the armature 10.

In the example provided the snap ring 22 and the hook retainer 15 are both positioned in the ‘6 o'clock position when the steering wheel 5 is in the straight ahead position but it will be appreciated that they could alternatively be positioned 180 degrees from this position corresponding to a ‘twelve o'clock position’ of the steering wheel 5.

Although in the example given the hook retainer is on the armature and the snap wire is attached to the airbag container it will be appreciated that the hook retainer could be on the airbag container and the snap wire could be attached to the armature.

It will also be appreciated that the two hook shaped members could alternatively be on the armature and the container could have corresponding apertures to form in combination with the two hook shaped members two spaced apart location means.

In the first embodiment shown in FIGS. 2 to 4, the airbag container 20 of the airbag module sits directly against the armature 10, trapping the trim member 13 between the airbag container 20 and the armature 10. With such an arrangement a floating cover has to be used for the airbag module 4 because the airbag container 20 is fixed.

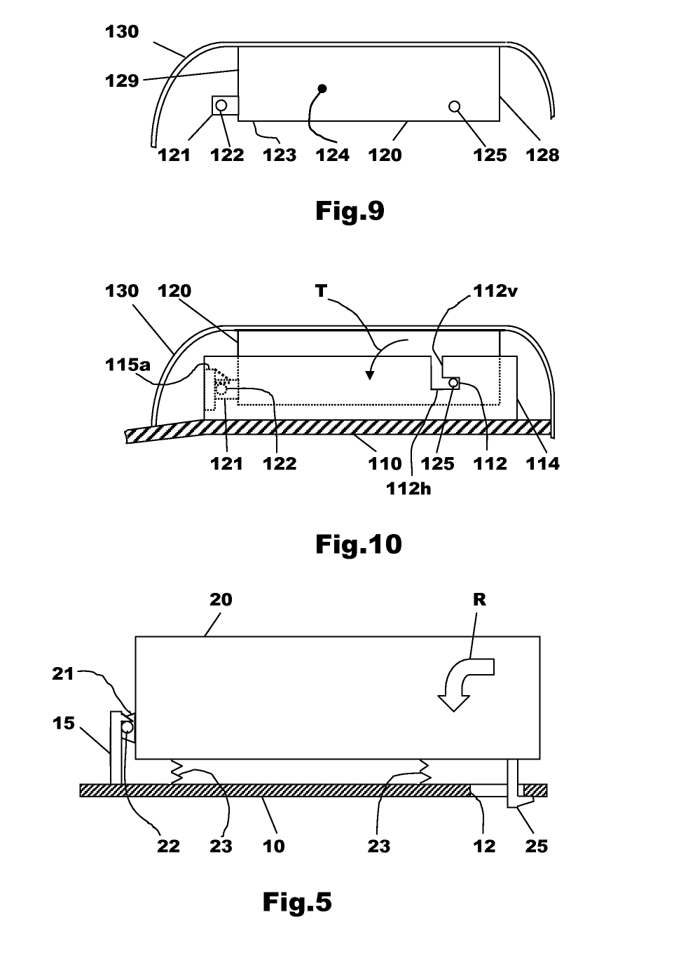

FIG. 5 shows a second embodiment that is in most respects identical to that shown in FIGS. 2 to 4 and differs therefrom only in that the airbag container 20 is floating and not fixed. To achieve this floating a number of helical springs 23 are interposed between the airbag container 20 and the armature 10 of the steering wheel 5 thereby allowing limited movement therebetween. The helical springs 23 are arranged in this case one adjacent to each of the two hook shaped members 25 and one adjacent to the location of the snap wire 22.

Referring now to FIGS. 6 to 10 there is shown a third embodiment of a driver airbag container and steering wheel for use in the steering wheel and driver airbag assembly 1 shown in FIG. 1.

An armature 110 of the steering wheel 5 has a support 114 for the driver airbag module 4 either formed as an integral part thereof or fastened thereto. The support 114 has two side walls in each of which is formed a respective L-shaped slot 111, 112.

Each slot 111, 112 has a first section lily, 112v open at one end and joined at an opposite end to one end of a second section 111h, 112h arranged normal to the first section 111v, 112v. The first sections 111v, 112v are arranged substantially normal to the armature 110 and the second sections 111h, 112h are arranged substantially parallel to the armature 110

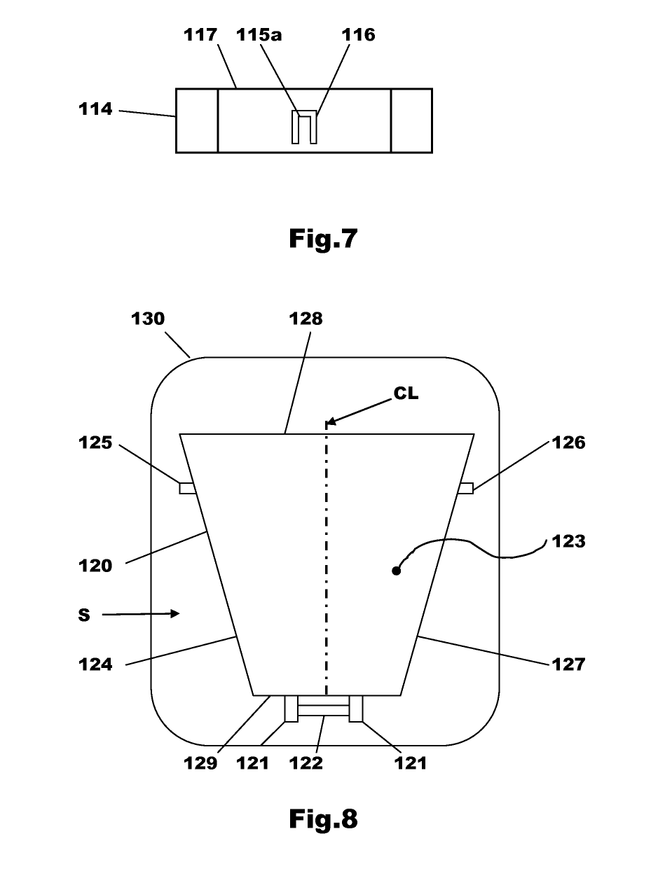

A hook shaped retainer 115 (shown in dotted outline on FIG. 6) extends from the armature 110 or, as shown by reference numeral 115a in FIGS. 7 and 10, is formed as part of an end wall 117 of the support 114. In the latter case an inverted U-shaped slot 116 separates three sides of the hook shaped retainer 115 from the end wall 117 so as to permit the hook shaped retainer 115 to move slightly relative to the end wall 117.

The airbag module 4 in the form of an airbag container 120 is provided for fitment to the support 114 and comprises an upper side to which is attached a cover member 130 through which an airbag (not shown) can be deployed, two side walls 124, 127, two end walls 128, 129 and a base wall 123. The airbag and its inflator (not shown) are stored in the airbag container 120 prior to deployment. The inflator is connected to an electrical circuit of a motor vehicle of which the steering wheel and driver airbag assembly 1 forms a part by a fly lead (not shown).

Each of the side walls 124, 127 has a respective pin 125, 126 extending out therefrom to form part of a location means for the airbag container 120. The pins 125, 126 are position on either side of a center line ‘CL’ of the airbag container 120 near to one end wall 128 of the container 120.

An opposite end wall 129 has a snap wire 122 fastened thereto by means of a pair of spaced apart lugs 121. The snap wire 122 forms one half of a single snap fastener used to attach the airbag container 120 to the steering wheel.

To attach the airbag container 120 to the steering wheel 5, the airbag container 120 is first offered up to the support 114 at an angle and the electrical connection between the airbag module 4 and the steering wheel 5 are made by connecting the fly lead to a connector (not shown) on the steering wheel 5.

The airbag container 120 is then moved towards the support 114 so as to engage the two pins 125, 126 with the open ends of the first sections 111v, 112v of the L-shaped slots 111, 112.

The airbag container 120 is then rotated in the direction of arrow ‘T’ on FIG. 10 until the snap wire 122 contacts an upper sloping surface of the hook retainer 115 or 115a. Further rotation of the airbag container 120 in the direction of arrow ‘T’ causes the snap wire 122 to be deflected towards the end 129 of the adjacent airbag container 120 to which it is attached via the lugs 121. This allows the snap wire 122 to move down the upper sloping surface until eventually it snaps past a tip of the hook retainer 115 or 115a and then becomes trapped under a flat lower surface of the hook shaped retainer 115 or 115a.

During the rotation of the airbag container 120 into engagement with the hook retainer 115 or 115a the airbag container 120 rotates about a transverse axis extending between contact or pivot points produced by the contact of the two pins 125, 126 with a respective side wall of the first sections 111v, 112v.

As the airbag container 120 is being rotated, the two pins 125, 126 slide down the first sections 111v, 112v of the L-shaped slots 111, 112 until they engage with adjoining ends of the second sections 111h, 112h of the L-shaped slots 111, 112. The pins 125, 126 then slide along the second sections 111h, 112h of the L-shaped slots 111, 112 as the snap wire 122 is engaged with the hook retainer 115, 115a.

Once the snap wire 122 is trapped by the hook retainer 15 the airbag container 120 is retained in place and the pins 125, 126 are prevented from disengaging from the horizontal portions 111h, 112h of the L-shaped slots.

The engagement of the pins 125, 126 with the L-shaped slots 111, 112 locates the airbag container 120 so as to prevent any motion towards or away from the armature 110 and the engagement of the airbag container 120 with the support 114 prevents any lateral movement of the airbag container 120.

In the case of the hook retainer 115 shown on FIG. 6, the hook retainer 115 is substantially rigid and so all of the deflection required for the engagement of the snap wire 122 therewith is due to deflection (bending) of the snap wire 122.

However, in the case of the hook retainer 115a shown in FIGS. 7 and 10 the hook retainer 115a can itself deflect because it is in the form of a resilient leaf having a hooked end. Therefore during engagement of the snap wire with the hook retainer 115a there is deflection of both the snap wire 122 and the hook retainer 115a and so the engagement force required is less than is the case with the rigid hook retainer 115. In addition, with such an arrangement the snap wire 122 could be replaced by a rigid finger extending out from the end wall 129 which engages with the hook retainer 115a. See for example, the finger 225 shown on FIG. 12.

Although in the example shown in FIGS. 6 to 10 the hook retainer is either on the armature 110 or on the support 114 and the snap wire 120 is attached to the airbag container 120 this need not be the case.

FIGS. 11A to 12 show for example an arrangement where the hook retainer is in the form of a finger 225 on the airbag container 120 and the snap wire 222 is attached to an end wall 217 of an airbag support 214. The snap wire 222 is attached by a pair of spaced apart lugs 221 to a free end of a leaf spring 223 formed in the end wall 217 by an inverted U-shaped slot 216.

During assembly of the airbag container 120, the airbag container 120 is, as previously described, rotated so as to bring the finger 225 into contact with the snap wire 222 but in this case the leaf spring 223 deflects to allow the finger 225 to pass by the snap wire 222 into the locked position shown in FIG. 12.

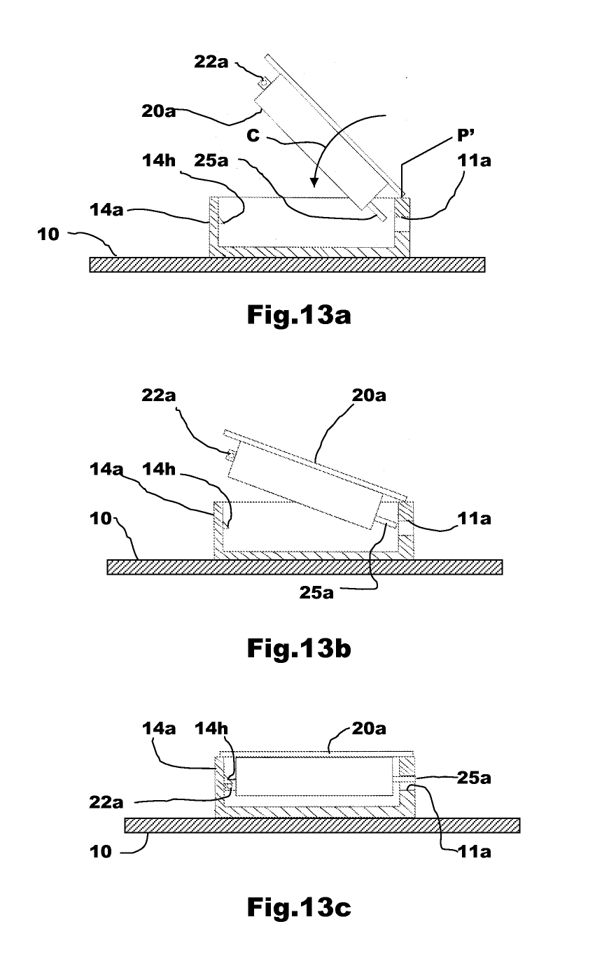

FIGS. 13A to 13C show a fourth embodiment of a driver airbag module which is similar to the first embodiment. The airbag container 20a has a pair of location arms 25a but in this embodiment they extend out from an end wall for engagement with a pair of apertures 11a formed in a wall of an airbag support 14a fastened to the armature 10. Although the location arms 25a are shown as linear components it will be appreciated that they could be curvilinear components having a radius approximately the same as their spacing from a transverse pivot axis indicated as P′ on FIG. 13a. As in the case of the first embodiment, a snap wire 22a is attached to the airbag container 20a for engagement with a hook element 14h formed as part of the support 14a.

Assembly is as for the first embodiment, the container 20 forming part of a driver airbag module is moved at an angle until contact is made with the support 14. Any electrical connections are then made and the airbag container 20a is rotated about the pivot axis P′ in the direction of the arrow ‘C’ on FIG. 13A.

Further rotation causes the location arms 25a to move along an arc towards the apertures 11 a with which they engage as the rotation continues. The rotation of the airbag container 20a causes the snap wire 22a to come into contact the hook element 14h. Further rotation of the airbag container 20a from this position causes the snap wire 22a to ride over the hook element 14h and this may be accompanied by a small amount of axial sliding of the airbag container 20a. This final rotation completes the engagement of the snap wire 22a with the hook element 14h and fully engages the location arms 25a with the apertures 11a.

Therefore in summary, the invention provides a single hook and snap wire in a 6 o'clock or 12 o'clock location with two location members located either side of a center line of the airbag container.

Assembly of the driver airbag module to the steering wheel is by engagement of the upper two location features and then rotation of the airbag module into the lower snap fixing.

Geometric location and centering of the module may be assisted by additional location features such as, for example and without limitation a centering blade in the 12 o'clock area and a peg in the 6 o'clock area to give longitudinal (X axis) and lateral (Y axis) location of the airbag container. Z axis location is provided by the primary retention faces of the snap fastener and the location means.

As with conventional steering wheel and driver airbag assembly the snap lock and location features can be formed on either the steering wheel or the airbag container.

As well as reducing the cost of manufacture and assembly this invention provides a more stable mounting of the airbag container.

Assembly is aided by the ease by which the inflator wiring can be connected before rotating the airbag container/module into position on the steering wheel. The use of the rotation into position feature allows a reduction in the length of electrical wire length required to connect the airbag container to the steering wheel. This reduces the risk of trapping of the wire during assembly.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for attaching an airbag module having a first part of a snap fastener to a steering wheel having a second part of the snap fastener, the method comprising:
positioning the airbag module at an angle relative to the steering wheel such that a part of the airbag module spaced from the first part of the snap fastener contacts the steering wheel to establish a pivot axis: and
rotating the airbag module about the pivot axis towards the steering wheel to cause the first and second parts of the snap fastener to engage one another.

2. The method of claim 1 wherein the first part of the snap fastener comprises one of a hook and a snap wire, and the second part of the snap fastener comprises the other of the hook and the snap wire.

3. The method of claim 1 wherein the rotation of the airbag module towards the steering wheel causes two location features disposed on the airbag module to become engaged respectively with two complementary location features disposed on the steering wheel, the engagement locating the airbag module relative to the steering wheel.

4. A steering wheel and driver airbag assembly comprising:
an airbag container for attachment to a steering wheel having two location means spaced from one another on opposite sides of a longitudinal center line of the airbag container for locating one end of the airbag container relative to the steering wheel, and a snap fastener having a first element on the steering wheel and second element on the airbag container, the first and second elements mating with one another to retain an opposite end of the airbag container in position on the steering wheel, wherein the airbag container is attached to the steering wheel by rotation of the airbag container about a transverse axis spaced away from the snap fastener so as to engage the first and second snap fastener elements thereby attaching the airbag container to the steering wheel.

5. The assembly of claim 4 wherein the first snap fastener element comprises one of a hook retainer and a snap wire and the second snap fastener element comprises the other of the hook retainer and the snap wire.

6. The assembly of claim 4 wherein the two location means comprise a pair of arms extending from the airbag container and respective matingly engageable with a pair of apertures in the steering wheel.

7. The assembly of claim 6 wherein the arms extend from a rear wall of the airbag container for mating engagement with respective apertures formed in an armature of the steering wheel.

8. The assembly of claim 6 wherein the arms extend from an end wall of the airbag container for mating engagement with respective apertures in an airbag support portion of the steering wheel.

9. The assembly of claim 6 wherein at least one of the arms is hook shaped.

10. The assembly of claim 4 wherein at least one of the two location means comprises a pin extending from a side wall of the airbag container to engage an L-shaped slot formed in the steering wheel.

11. The assembly of claim 10 wherein the L-shaped slot has a first section having an open end which engages the pin during attachment of the airbag container to the steering wheel, and wherein the pin contacts a side wall of the first arm at a contact point and the transverse axis of rotation passes through the contact point.

12. The assembly of claim 11 wherein the pin slides away from the open end of the first arm with which it is engaged as the airbag container is rotated to engage the snap fastener thereby facilitating engagement of the pin with the second section of the L-shaped slot.
